(19) United States
(12) Patent Application Publication
(10) Pub. No.: US 2025/0152459 A1
(43) Pub. Date: May 15, 2025

(54) RECIPROCATING STIMULATION DEVICE

(71) Applicant: HYTTO PTE. LTD, Singapore (SG)

(72) Inventors: Dan LIU, Guangzhou (CN); Jilin QIU, Guangzhou (CN)

(73) Assignee: HYTTO PTE. LTD, Singapore (SG)

(21) Appl. No.: 19/006,706

(22) Filed: Dec. 31, 2024

Related U.S. Application Data
(63) Continuation-in-part of application No. 18/581,680, filed on Feb. 20, 2024.
Application No. 18/581,680 is a continuation-in-part of application No. 18/307,753, filed on Apr. 26, 2023, now Pat. No. 12,178,774.
Application No. 18/307,753 is a continuation-in-part of application No. 17/820,579, filed on Aug. 18, 2022.
Application No. 17/820,579 is a continuation-in-part of application No. 18/385,180, filed on Oct. 30, 2023, now Pat. No. 12,042,460.
Application No. 18/385,180 is a continuation of application No. 17/968,463, filed on Oct. 18, 2022, now Pat. No. 11,833,102.

(51) Int. Cl. A61H 19/00

(52) U.S. Cl. CPC A61H 19/44; A61H 2201/0153; A61H 2201/018; A61H 2201/1215; A61H 2201/149; A61H 2201/1664; A61H 2201/5058

(57) ABSTRACT

A reciprocating stimulation device includes a handle portion, a stimulation body disposed over the handle portion and including a stimulation component arranged at a tip thereof, a first drive assembly having a first motor configured to drive the stimulation body in a reciprocating motion, and a second drive assembly having a second motor configured to drive the stimulation component in a thrusting motion.

### CROSS REFERENCE TO RELATED APPLICATION

This application is a Continuation-In-Part of U.S. application Ser. No. 18/581,680, filed on Feb. 20, 2024, which is a Continuation-In-Part of U.S. application Ser. No. 18/307,753, filed on Apr. 26, 2023, now U.S. Pat. No. 12,178,774, issued Dec. 31, 2024. U.S. application Ser. No. 18/581,680 is also a Continuation-In-Part of U.S. application Ser. No. 17/820,579, filed on Aug. 18, 2022. U.S. application Ser. No. 18/581,680 is also a Continuation-In-Part of U.S. application Ser. No. 18/385,180, filed on Oct. 30, 2023, now U.S. Pat. No. 12,042,460, issued Jul. 23, 2024, which is a Continuation of U.S. application Ser. No. 17/968,463, filed Oct. 18, 2022, now U.S. Pat. No. 11,833,102, issued Dec. 5, 2023. Each of the above applications is hereby incorporated by reference in its entirety.

### TECHNICAL FIELD

The present disclosure relates to sexual stimulation devices and, more specifically, to a reciprocating sexual stimulation device.

### DISCUSSION OF THE RELATED ART

Sexual stimulation devices, sometimes known as sex toys or adult toys, are designed to produce a range of different motions such as vibrating, rotating and thrusting. Thrusting motions may be generated by the action of reciprocating in which an element may move forward and backward in a line. Since such devices generally use an electric motor that is capable of producing rotational movement, reciprocating action may be produced by such mechanical elements as cams, that convert the rotational motion of the motor into reciprocating motion, or push rods mounted to a rotating disk or wheel driven to push and pull the rod generally along the reciprocating direction.

However, such existing approaches for providing reciprocating action may be poorly suited for use within sexual stimulation devices owing to inefficiencies in power utilization, the need for awkward device shaping to accommodate the needed mechanical elements, limited stroke length, weak drive force for portable arrangements, an asymmetrical ascending and descending stroke force.

### SUMMARY

A reciprocating stimulation device comprises a handle portion and a stimulation body disposed over the handle portion. The stimulation body includes a stimulation component arranged at a tip thereof. The reciprocating stimulation device further comprises a first drive assembly and a second drive assembly. The first drive assembly has a first motor configured to drive the stimulation body in a reciprocating motion. The second drive assembly has a second motor configured to drive the stimulation component in a thrusting motion.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a perspective view of the reciprocating stimulation device in accordance with exemplary embodiments of the present invention;

FIG. 2 is an exploded view of the reciprocating stimulation device in accordance with exemplary embodiments of the present invention;

FIG. 3 is a perspective view of a first drive assembly in accordance with exemplary embodiments of the present invention;

FIG. 4 is an exploded view of the first drive assembly depicted in FIG. 3;

FIG. 5 is another perspective view of a first drive assembly in accordance with exemplary embodiments of the present invention;

FIG. 6 is an exploded view of the first drive assembly depicted in FIG. 5;

FIG. 7 is a perspective view of a second drive assembly in accordance with exemplary embodiments of the present invention;

FIG. 8 is an exploded view of the second drive assembly depicted in FIG. 7;

FIG. 9 is another perspective view of a second drive assembly in accordance with exemplary embodiments of the present invention;

FIG. 10 is an exploded view of the first drive assembly depicted in FIG. 9;

FIG. 11 is a cutaway view showing the reciprocating stimulation device of FIG. 1;

FIG. 12 is another cutaway view showing the reciprocating stimulation device of FIG. 1;

FIG. 13 is an exploded view of a reciprocating stimulation device utilizing a dual-helical grooved screw;

FIG. 14 is a cutaway view of the reciprocating stimulation device shown in FIG. 13;

FIG. 15 is a set of perspective views of the screw with the nut assembly disposed thereon, as seen in FIGS. 11-14;

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide for a sexual stimulation device that utilizes various screw-and-nut arrangement to produce reciprocating action from a single-direction rotational movement of an electric motor so as to provide a desired vector of stimulation within a compact and portable shape while efficiently making use of battery power.

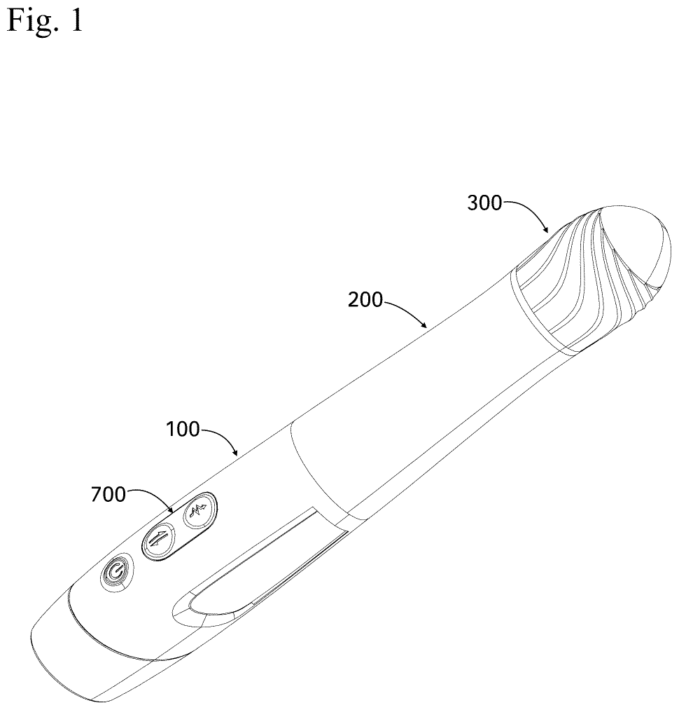

Reference to the FIG. 1, the FIG. 1 illustrates an exemplary embodiment of the disclosure of a reciprocating stimulation device, the device 10 can be a reciprocating device for an adult toy such as an accessory used for erotic stimulation. The device may be a sexual stimulation device that may be used by a female user and/or a male user. The device 10 may comprise a handle portion 100 and a stimulation body 200. For example, the stimulation body 200 may be disposed over the handle portion 100, the stimulation body 200 may include a stimulation component 300 which can be arranged at a tip of the stimulation body 200.

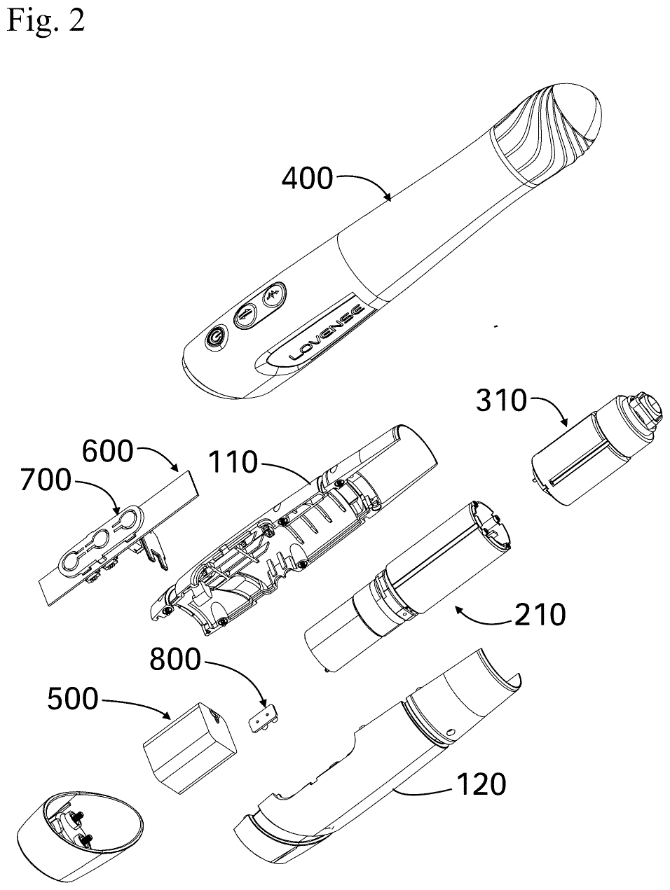

In at least some exemplary embodiments, reference to the FIG. 2, device 10 may further comprise a first drive assembly 210 and a second drive assembly 310. For example, the first drive assembly 210 may include a first motor 211 which can drive the stimulation body 200 in a reciprocating motion. For example, the second drive assembly 310 may include a second motor 311 which can drive the stimulation component in a thrusting motion.

In at least some exemplary embodiments, reference to the FIGS. 2, 1 land 12, the handle portion 100, the stimulation body 200 and the stimulation component 300 may both be covered by a flexible cover member 400, and at least a portion of the flexible cover member 400 wrapped around the stimulation body 200 or the stimulation component 300 may form as a stretchable tube. In such a case, the handle portion 100 may comprise a first shell 110 and a second shell 120, with the first shell 110 and the second shell 120 fitting together to form an internal hollow portion that can accommodate at least a portion of the battery 500, the circuit board 600, at least a portion of the button assembly 700, and at least a portion of the charging assembly 800. The internal hollow portion may also contain at least a portion of the first drive assembly 210 (e.g., the first drive motor 211). In other cases, the stimulation component 300 may include a third motor (not shown in the FIGS) for generating vibrations.

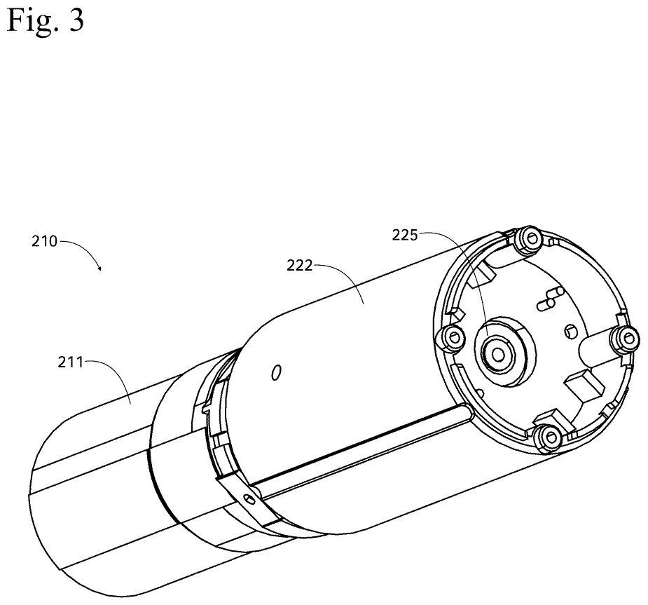

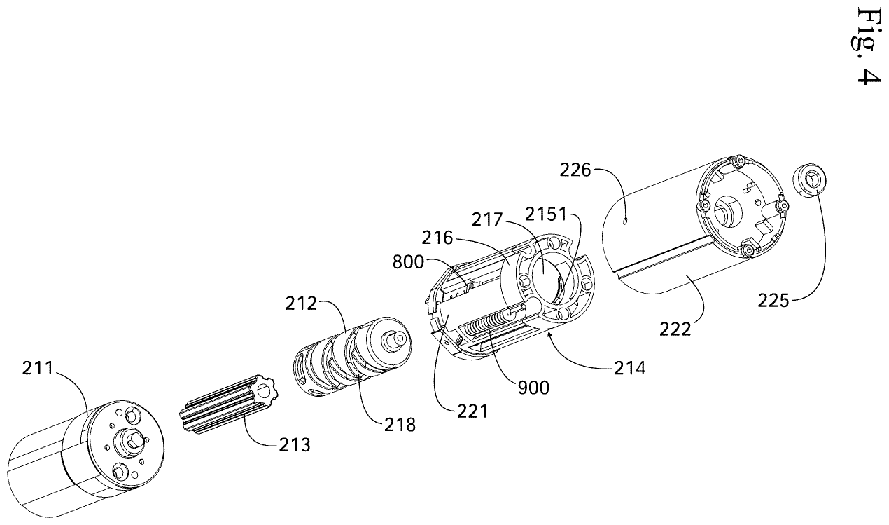

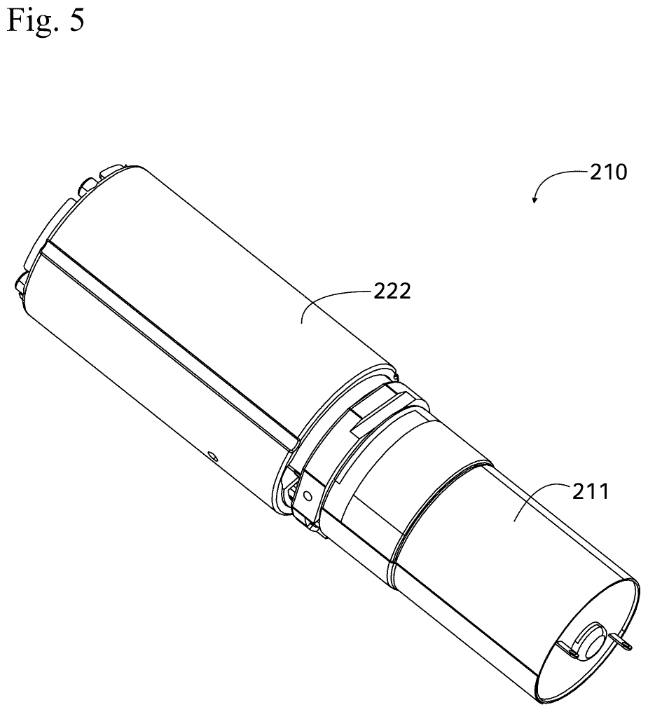

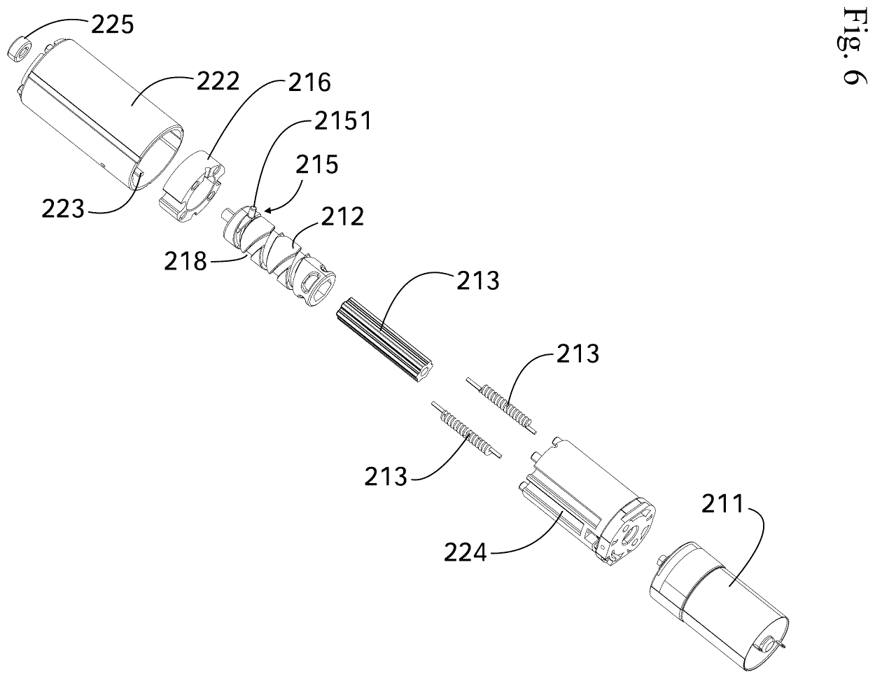

In at least some exemplary embodiments, reference to the FIGS. 3-6, the device 10 may comprise a first guide structure coupled to the handle portion 100 and extending to the stimulation body 200. For example, the first guide structure may include a sleeve 221 housing at least a portion of the first drive assembly 210 and a cylindrical shape loaded member 222 which may surround the sleeve 221. In one embodiment, the inner lateral wall of the loaded member 222 may be provided with at least one first elongate projection 223 extending along an axis thereof, and the outer lateral wall of the sleeve 221 may be provided with a first elongate groove 224 that corresponding with the first elongate projection 223. With the rotation of the first motor 211, the loaded member 222 may be actuated by the first drive assembly 210 to linearly reciprocate relative to the sleeve 221 sliding linearly back and forth with respect to the sleeve 221. In one embodiment, the second drive assembly 310 may be secured to the top of the loaded member 222, and as the loaded member 222 can be in linear reciprocal sliding with respect to the sleeve 221, the second drive assembly 310 reciprocates linearly with the sliding of the loaded member 222, resulting in the stimulation body 200, together with the stimulation assembly 300, to be in a linear reciprocal motion with respect to the handle portion 100.

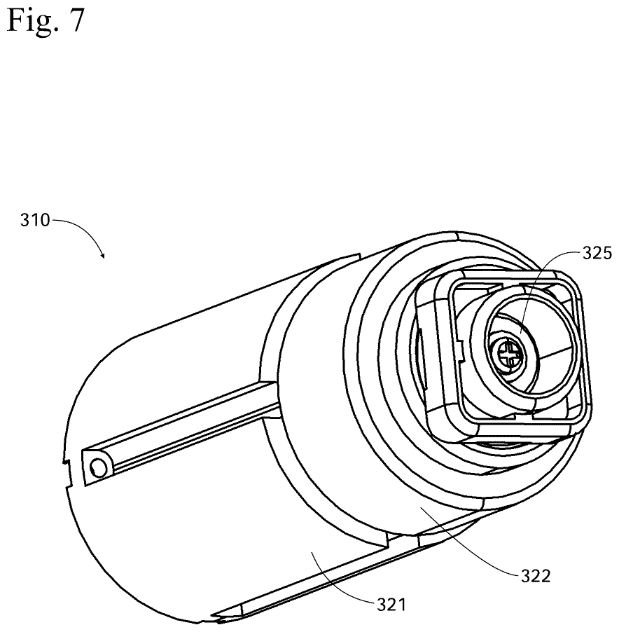

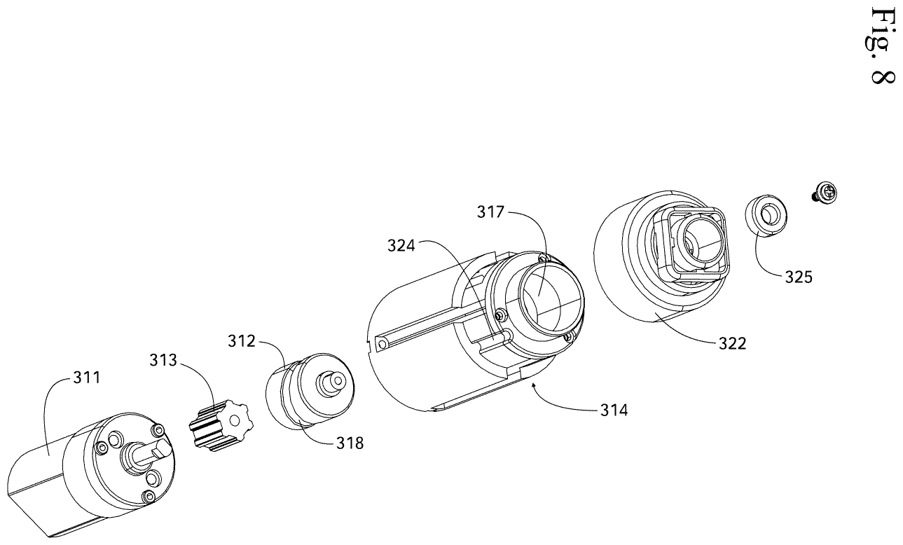

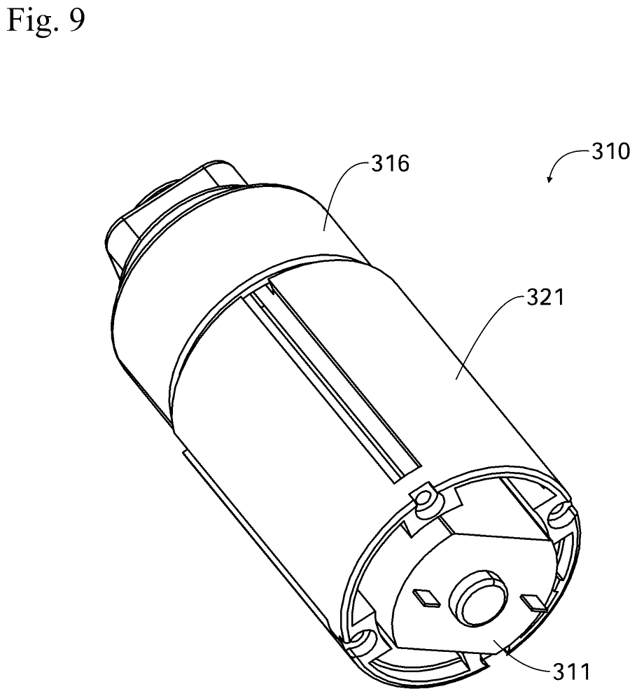

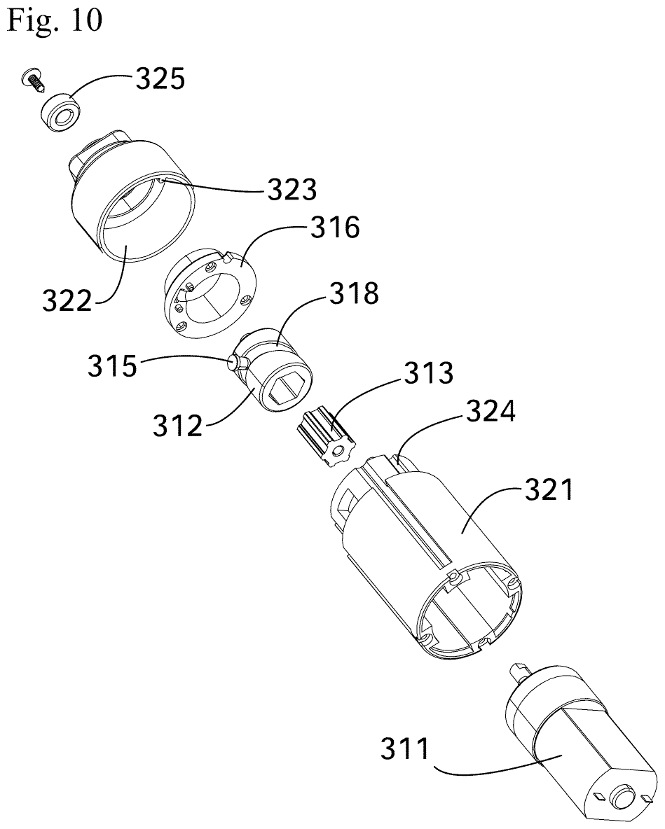

In at least some exemplary embodiments, referring to FIGS. 7-10, the reciprocating stimulation device 10 may also include a second guide structure coupled to the support member 321 and extending to the stimulation component 300. For example, the second guide structure may include a support member 321 housing at least a portion of the second drive assembly 310 and a thrusting member 322. In one embodiment, the thrusting member 322 is cylindrical and can sleeve at least a portion of the support member 321, an inner lateral wall of the thrusting member 322 can be provided with at least one second elongate projection 323 extending along its axis, and an outer lateral wall of the support member 321 can be provided with a second elongate slot 324 that corresponding with the second elongate projection 323. As the second motor 311 rotates, the thrusting member 322 can be driven by the second drive assembly 310 and linearly reciprocally thrusting relative to the support member 321.

In at least some exemplary embodiments, reference to the FIGS. 3-6, the first drive assembly 210 may include a first screw 212 rotatably coupled to the stimulation body 200. For example, the first screw 212 may be rotatably coupled to the loaded member 222. the first drive assembly 210 may also include a first torque receiving structure 213 and a first nut component 214.

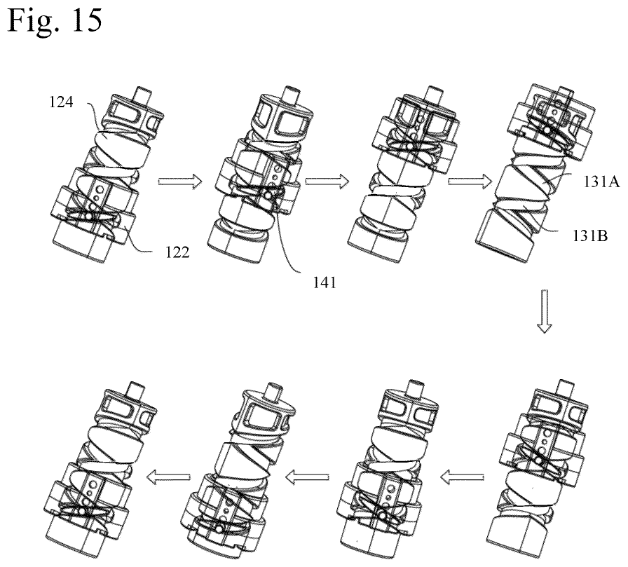

In at least some exemplary embodiments, reference to the FIGS. 3-6 and 15, the first nut member 214 may be formed by at least a portion of the sleeve 221, a longitudinal force structure arranged on the top surface of the sleeve 221 such as a crescent-shaped guide pin 215, and an annular upper cover 216 arranged on the top surface of the sleeve 221. A cylindrical portion 2151 of the crescent-shaped guide pin 215 is rotatably secured with the annular top cover 216 fit on the top surface of the sleeve 221 as it is rotatably secured, and the annular top cover 216 fitting the top surface of the sleeve 221 creates a first opening 217 disposed within the first nut component 214, with the arcuate portion 2152 of the crescent-shaped guide pin 215 extending into the first opening 217. The first opening 217 of the first nut component 214 may also be passed through by the first screw 212, and the arcuate portion 2152 may fit into a dual-helical groove 218 of the first screw 212.

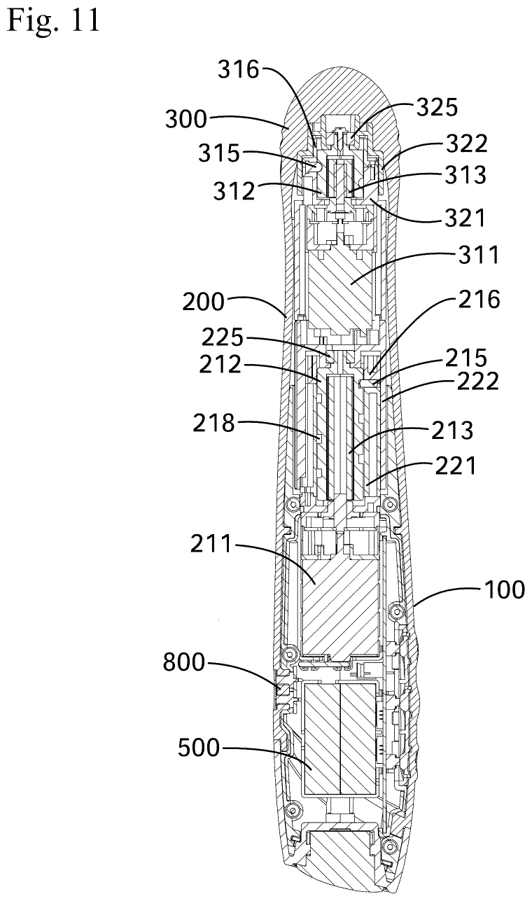

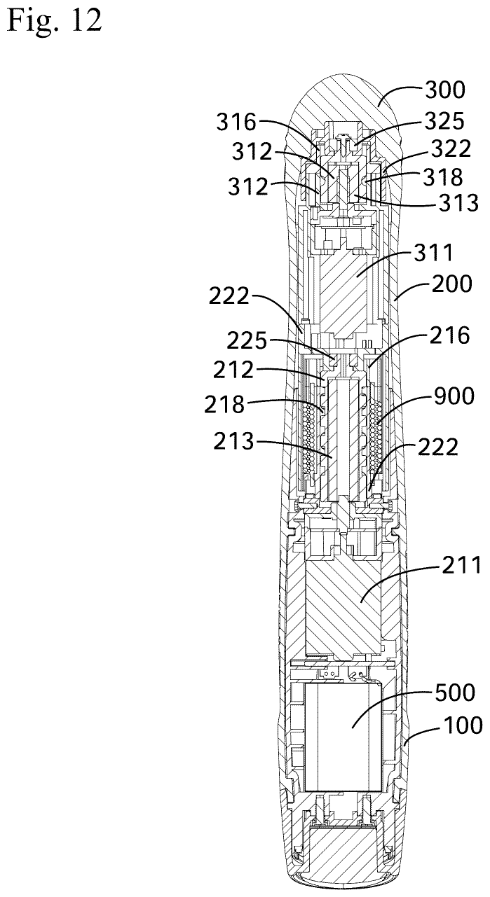

In at least some exemplary embodiments, reference to the FIGS. 3-6, and 11-12, the center of the first screw 212 may have a first cavity 219 open to the bottom of the first screw, the first torque receiving structure 213 may be a non-cylindrical post that transitionally fits into the first cavity 219, and the first screw 212 may be rotated within the first nut component 214 by the first torque receiving structure 213 being actuated by the first motor 211, causing the first screw 212 is free to move up and down as the first motor 211 rotates, resulting in the first screw 212 being able to drive the stimulation body 200 in reciprocating motion relative to the handle portion 100. In one embodiment, the first screw 212 rotatably coupled to the stimulation body 200 via a first bearing 225 that connects a top portion of the first screw 212 to a loaded member 222 of the stimulation body 200 to counteract torque generated on the stimulation body 200 during rotational movement of the first screw 212.

In at least some exemplary embodiments, reference to the FIGS. 7-12, the second drive assembly 310 may include a second screw rotatably coupled to the stimulation assembly 300 (e.g., the second screw may be replaced with a cylindrical cam 312), which may be rotatably coupled to the thrusting member 322. the second drive assembly 310 may also include a second torque receiving structure 313 and a second nut component 314.

In at least some exemplary embodiments, reference to the FIGS. 7-12 and 15, the second nut component 314 may be formed by at least a portion of the support member 321, and a longitudinal force structure (e.g., a columnar guiding pin 315) arranged on the top surface of the support member 321, and an annular top cover 316 arranged on the top surface of the support member 321. A fixed end of the columnar guiding pin 315 can be secured as the annular top cover 216 fills the bracket member 321. The fixed end of the column guide pin 315 can be secured as the annular top cover 216 fits over the top surface of the support member 321, and the annular top cover 316, when it fits over the top surface of the support member 321, forms a second opening 317 disposed within the second nut component 314, and the free end of the column guide pin 315 extends into the second opening 317. The second opening 317 of the second nut component 314 may also be traversed by a cylindrical cam 312, and the cylindrical guide pin 315 may fit into a milled groove 318 of the cylindrical cam 312.

In at least some exemplary embodiments, reference to the FIGS. 7-12, the center of the cylindrical cam 312 may have a second cavity 319 open to the bottom of the cylindrical cam 312, the second torque receiving structure 313 may be a non-cylindrical that transitionally fits into the second cavity 319, and the cylindrical cam 312 may be rotated within the second nut component 314 via the second torque receiving structure 313 that may be actuated by the second motor 311, causing the cylindrical cam 312 is free to move up and down as the second motor 211 rotates, resulting in the cylindrical cam 312 being able to drive the thrusting component 300 in a thrust movement relative to the handle portion 100. In one embodiment, the cylindrical cam 312 is rotatably coupled to the stimulation component 300 via a second bearing 325 that connects an upper portion of the cylindrical cam 312 to the thrust component 322 of the stimulation component 300 to counteract torque generated on the stimulation body 200 during rotational movement of the first screw 212. As the second screw is replaced with a cylindrical cam 312, and due to the milled groove 318 has a shorter stroke, resulting in a thrust movement stroke of the stimulation component 300 of from about 3 millimeters to about 15 millimeters, and a thrust frequency of the stimulation assembly 300 of from 1,000 to 3,000 thrusts per minute.

In at least some exemplary embodiments, reference to the FIGS. 3-6 and 12, the device 10 may further include a sensing stopper component spaced apart at the first drive assembly 210, a sensing element, and a controller. In one embodiment, the sensing stopper assembly may be a Hall sensor 800, which may be mounted on the outer side of the sleeve 221. In one embodiment, the sensing element may be a magnet (not shown in the figures), which is mounted on a mounting hole 226 in the sidewall of the cartridge loaded member 222, allowing the magnet to follow the linear motion of the stimulation body 200. In one embodiment, the controller (not shown in the figure) may be soldered to the circuit board 600, electrically connected to the Hall sensor 800 via a conductive structure. The controller receives a signal generated when the magnet enters the sensing range of the Hall sensor 800 and generates a reversal signal or a braking signal that causes the first motor 211 to reverse or brake. In one embodiment, the stimulation body 200 may perform reversed linear motion or braked linear motion in response to the reversal signal or braking signal.

In at least some exemplary embodiments, reference to the FIG. 7-12, the electrically conductive structure may include wires (not all of which are shown in the figure) that enable electrical connection between the battery 500, the circuit board 600, the first motor 210, and the Hall sensor 800. In one embodiment, the electrical connection between the battery 500 and the second motor 310 can be a spring-shaped pipe line 900, which may be arranged on elongate curved slots 2210 on each side of the sleeve 221. The spring-shaped pipe line 900 is periodically stretched and restored as the second motor 310 is driven by the first drive assembly 210 in a reciprocating motion.

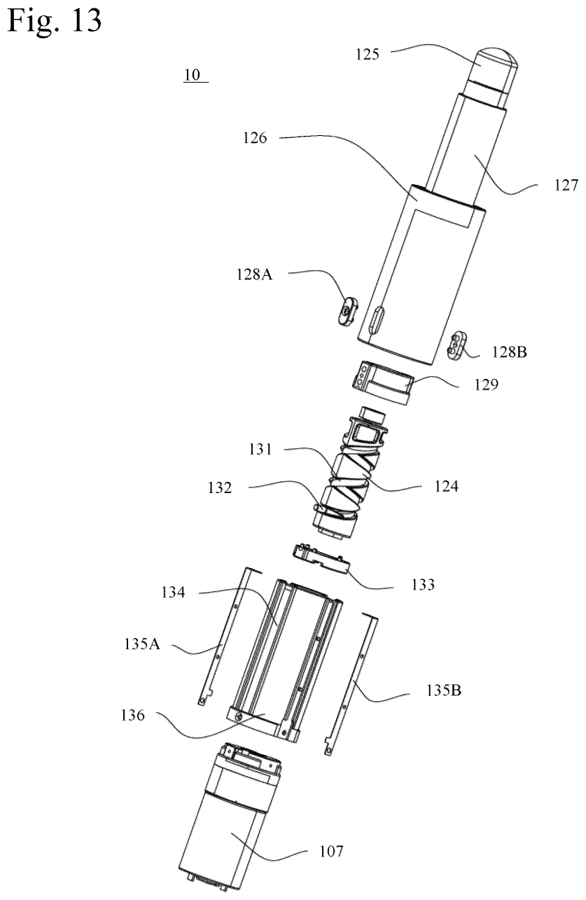

In at least some exemplary embodiments, reference to the FIGS. 13-15, a reciprocating stimulation device 10 utilizing a dual-helical grooved screw 124 in accordance with exemplary embodiments of the present invention. Here an inner sleeve 136 may be disposed over the rotating motor 107. The inner sleeve 136 may include a linear guiding hole 134. The screw 124 may also be disposed within the inner sleeve 136. The screw 124 is mated to the rotating motor 107 such that the rotating motor 107 spins the screw 124. The screw 124 has a dual-helical groove 131 in its surface that may include an ascending helical groove and a descending helical groove (i.e., levorotatory helical groove and a dextrorotatory helical groove). The two helical grooves are interlaced with one another and are connected end-to-end at both the top and bottom of the screw 124.

A nut is formed by the lower cover 133 and the upper cover 129 which come together with the guide pin 132. The guide pin 132 protrudes from the linear guide hole 134 of the inner sleeve 136. Thus, as the rotating motor 107 rotates, the nut formed by the lower cover 133 and the upper cover 129 move up or down depending on which of the two helical grooves the guide pin 132 is presently disposed within as the nut is prevented from rotation by the disposition of a bump within the linear guiding hole 134. As discussed above, the direction of travel of the nut changes as the guide pin 132 reaches either the top or bottom of the screw 124 and then passes to the other groove.

It is to be understood that the nut arrangement may include more than one guide pin 132, for example, it may include a pair of bumps disposed at opposite sides of the nut and these bumps may each be seated with a different linear guide hole 134 of the inner sleeve 136 and so there might be two linear guide holes 134 on opposite sides of the inner sleeve 136 to correspond to the pair of bumps. This may provide added stability over an embodiment in which there is only one bump being used.

An outer sleeve 126 is coupled to the nut formed by the lower cover 133 and the upper cover 129 by the placement of one or more mounts 128A and 128B. Thus, as the nut moves up and down, it carries the outer sleeve 126 up and down along with it. A support 127 is coupled to the outer sleeve 126 and a case 125 is coupled to the support 127 and in this way, the case 125 of the device 100 may achieve the desired reciprocating motion.

Power may be conducted from the base of the device to the top of the device, for example, to power a vibrational motor or other stimulation component disposed therein, by a pair of conductive strips 135A and 135B that may be disposed around the inner sleeve 136. Each of the conductive strips 135A and 135B may be electrically connected to a wire at its bottom that connects to the power source and a wire at its top that connects to the vibrational motor or other stimulation component. By using conductive strips in this manner, friction may be reduced between the inner sleeve 136, that remains stationary relative to the base, and the outer sleeve 126, that moves up and down relative to the base, as using wires between these two sleeves might well interfere with the reciprocating movement.

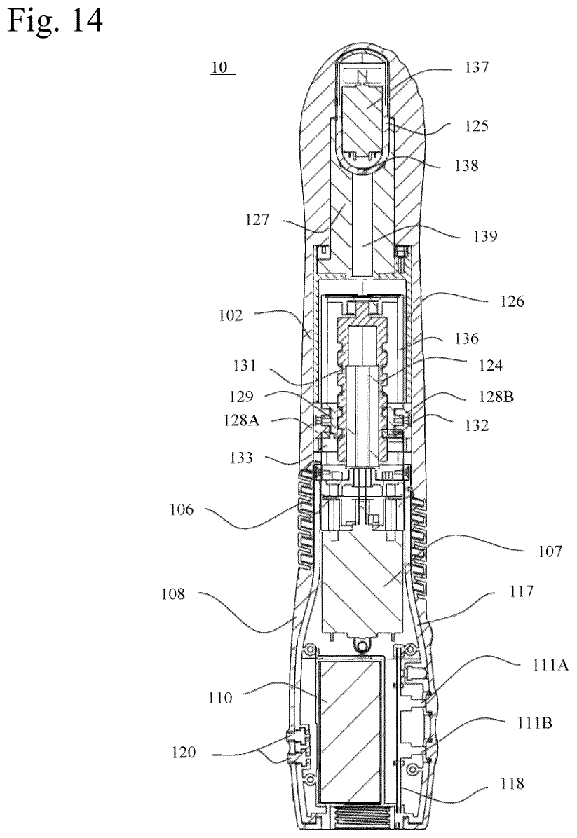

FIG. 14 is a cutaway view of the reciprocating stimulation device 10 shown in FIG. 13. The device 100 is illustrated here in its fully retracted state where the outer sleeve 126 is disposed around the inner sleeve 136. Here, the handle portion 108 encases the shell 117, the power source/battery 110, the rotating motor 107, and the PCB 118 with controller disposed thereon. The charging ports 120 and the buttons 111A/111B may protrude from the shell 117 and handle portion 108.

The handle portion 108 is again bridged with the stimulation body 102, on the exterior, by the stretchable tube 106. Within the inner sleeve 136, the screw 124 with its dual-helical grooves is coupled to the rotating motor 107. The lower cover 133 comes together with the upper cover 129 to form the nut that engages with the grooves 131 of the screw 124, for example, with the guide pin 132. A pair of mounts 128A and 128B fix the nut assembly, including the lower cover 133, the upper cover 129, and the guide pin 132, to the outer sleeve 126. The outer sleeve 126 is coupled to the stimulation body 102 and above the outer sleeve 126, and within the stimulation body 102, is the support 127. A chamber 139 may run through the support 127 and wires may run within the chamber 139, emerge through a first hole 138 in the case 125 so as to power the vibrating motor 137 disposed within the top of the stimulation body 102.

In the various figures, many of the same elements are shown in multiple figures but are not described again with respect to each and every figure in which they appear. Accordingly, it is to be assumed that to the extent that an element is not described with respect to one figure, it is at least similar to a corresponding element shown and described with respect to another figure. Like reference numerals may represent like elements throughout the specification and the figures.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

1. A reciprocating stimulation device comprising:
a handle portion;
a stimulation body disposed over the handle portion and including a stimulation component arranged at a tip thereof;
a first drive assembly having a first motor configured to drive the stimulation body in a reciprocating motion; and
a second drive assembly having a second motor configured to drive the stimulation component in a thrusting motion.

2. The reciprocating stimulation device of claim 1, further comprising a stretchable tube connecting an exterior of the handle portion with an exterior of the stimulation body.

3. The reciprocating stimulation device of claim 1, wherein the stimulation component comprises a third motor for generating vibration.

4. The reciprocating stimulation device of claim 1, further comprising a guiding structure coupled to the handle portion and extending to the stimulation body.

5. The reciprocating stimulation device of claim 1, wherein at least one of the first drive assembly and the second drive assembly further comprises:
a screw rotatably coupled to the stimulation body and including a cavity within its center that is open to a bottom thereof;
a torque receiving structure coupling the screw and the first motor or the second motor, the torque receiving structure being at least partially inserted into the cavity of the screw so as to rotate the screw by rotation of the first motor or the second motor; and
a nut coupled to the handle portion, the screw being threaded through an opening of the nut,
wherein the screw is configured to drive at least one of a reciprocating and a thrusting motion of the stimulation component relative to the handle portion as the torque receiving structure drives the screw to rotate within the nut.

6. The reciprocating stimulation device of claim 5, wherein:
the torque receiving structure comprises a non-circular post that is transition fit with the cavity, and
the screw is rotated by the first motor or the second motor via the torque receiving structure which allows the screw to freely move up and down as the first motor or the second motor rotates.

7. The reciprocating stimulation device of claim 5, further comprising a bearing coupling a top portion of the screw to the stimulation body to counteract an amount of torque generated on the stimulation body as the screw is in rotating motion.

8. The reciprocating stimulation device of claim 1, wherein at least one of the first drive assembly and second drive assembly further comprises:
a screw coupled to at least one of the first motor and the second motor via a torque receiving structure and configured to be driven in rotation by the first motor or the second motor;
a nut component coupled to the stimulation body, the screw being threaded through an opening of the nut component; and
a guiding structure coupled to the handle portion and extending to the stimulation body, the guiding structure being configured to prevent the nut from rotating with respect to the handle portion,
wherein the nut is configured to drive at least one of a reciprocating and a thrusting motion of the stimulation component relative to the handle portion as the screw rotates therein.

9. The reciprocating stimulation device of claim 8, wherein the screw includes a helical groove having a head end and a tail end connected to each other, thereby defining a closed-up ring groove.

10. The reciprocating stimulation device of claim 1, further comprising:
a sensing stopper component arranged on a side of the first drive assembly with a space therebetween;
a sensing element configured to follow a linear motion of the stimulation body; and
a controller configured to receive signals generated when the sensing element enters a sensing range of the sensing stopper component and to generate a reverse signal or a brake signal, thereby controlling the first motor to reverse or brake,
wherein the stimulation body performs reverse linear motion or brake linear motion according to the reverse signal or the brake signal.

11. The reciprocating stimulation device of claim 1, further including a battery disposed within the handle portion and electrically connected to the motor and the stimulation component via conductive structures.

12. The reciprocating stimulation device of claim 11, wherein the conductive structures include a spring shaped pipe line electrically connected to the battery and the second motor.

13. The reciprocating stimulation device of claim 1, wherein:
a stroke length of the thrusting motion of the stimulation components is about 3 mm to about 15 mm, and
a frequency of the thrusting motion of the stimulation component is 1000 to 3000 times per minute.
